(19) United States
(12) Patent Application Publication
(10) Pub. No.: US 2026/0050288 A1
(43) Pub. Date: Feb. 19, 2026

(54) SYSTEM AND METHOD FOR LOCKLESS TIMER SYNCHRONIZATION

(71) Applicant: Kinaxis Inc, Ottawa (CA)

(72) Inventors: Maxim Creanga, Ottawa (CA); Marin Creanga, Ottawa (CA); Robert Duncan Klett, Ottawa (CA)

(73) Assignee: Kinaxis Inc, Ottawa (CA)

(21) Appl. No.: 19/300,744

(22) Filed: Aug. 15, 2025

Related U.S. Application Data
(60) Provisional application No. 63/683,361, filed on Aug. 15, 2024.

(51) Int. Cl. G06F 1/14

(52) U.S. Cl. CPC G06F 1/14

(57) ABSTRACT

Systems and methods for lockless timer synchronization, comprising a client, an administrator client device 112 and a server. The administrator client device 112: initializes a timer for an operation; sets a duration for the operation, and starts the timer. The client makes one or more requests for the amount of time left on the timer, before the timer expires. The administrator client device 112 can adjust the duration of the operation, while the timer is paused or unpaused. The administrator client device 112 can pause or unpause the timer.

This application claims priority to U.S. Provisional Patent Application 63/683,361 filed on Aug. 15, 2024, which is incorporated herein in its entirety, by reference.

### BACKGROUND

There are many challenges involved in managing a timed, electronic competition between clients. For example, there are challenges involved when everything is on the client side; in such a situation, everyone is competing for a single resource, or everyone is tracking a single resource like a stopwatch or a timer. While each client independently counts down an identical time period, each client's computer can count down at a different rate, resulting in an unfair advantage for some clients. Even the difference of one second can be too much, resulting in an unfair advantage; that is, unsynchronized computers can lead to uneven time periods. In addition, a client can cheat by simply refreshing their application, and thus start counting down again from the beginning, thereby obtaining added time.

One way to address such situations is to synchronize client computers through a centralized server. Once such a server is in place, the process operates such that clients are not blocked, and the network speed is even throughout the distributed network of client computers.

In certain instances, such as a timed competition between clients, there is a need to be able to count down a time period, allow certain operations to take place during that time period, and disallow said operations after the time period has expired. This process is distributed across many clients who are independently trying to perform an operation, with the caveat that each client is only allowed to execute the operation if time permits; however, if the client is not allowed to do the operation simply based on the current time and what time constraints an administrator sets, then the client should be denied execution of the action. That is, a major step in administering such a scenario is to determine if and when an operation should be allowed or disallowed, via the means of a centralized server.

Here are a few examples where an administrator has decided that an operation can be performed during a certain time period. In such instances, multiple clients are connected to a server to perform one or more operations. Each operation is time sensitive and is only available for a set amount of time. For example, operation A is available between 9:00 AM to 10:00 AM. In another example, operation B is only available for 30 minutes starting at 9:30 AM. In another example, operation C is only available for 10 minutes starting now.

In a timed competition, each client needs to know not only the time period when a particular operation is accessible, but must also accurately know how much time is left for a particular operation. For example, if user Z logs in at 9:45 AM, a timer should display 15 min left on operation A. Furthermore, a user may ask at different points in time, how much time they have left to perform a certain operation (for example, a countdown such as “10, 9, 8. . . ” may be requested).

In addition, an administrator needs to be able to manually start/pause the timer. For example, the administrator may log in at 9:00 AM and pause the timer for operation A for 10 min, then unpause. After 10 mins, at 9:10 AM, a client's timer should display 60 min remaining (not 50 min). In addition, the administrator can extend the time allowed for a given operation—which means each client's timer goes down. Or, if the administrator pauses the timer to perform some maintenance work, then each client's timer is also paused.

### BRIEF SUMMARY

There is thus a need to store various pieces of information about available operations on the server side. A client periodically requests from the server, the latest information about the operation. The client then updates the presented information based on the response. An administrator is then able to directly change the information on the server side that would be reflected on the client next time the client inputs a request.

In one aspect, a computer-implemented method is provided, that includes a) initializing, by a processor, a timer for an operation, b) setting, by the processor, a duration of the timer, c) starting, by the processor, the timer, d) receiving, by the processor, a request from a client for an amount of time left on the timer, e) determining, by the processor, the amount of time left on the timer, f) returning, by the processor, to the client, the amount of time left on the timer, and g) repeating steps (d)-(f) until the timer expires.

The computer-implemented method may further comprise: f.1) adjusting, by the processor, the duration. The computer-implemented method may further comprise at least one of f.2) pausing, by the processor, the timer, and f.3) unpausing, by the processor, the timer. Other technical features may be readily apparent to one skilled in the art from the following figures, descriptions, and claims.

In one aspect, a computing apparatus is provided. The computing apparatus includes a processor. The computing apparatus also includes a memory storing instructions that, when executed by the processor, configure the apparatus to a) initializing, by the processor, a timer for an operation, b) set, by the processor, a duration of the timer, c) start, by the processor, the timer, d) receive, by the processor, a request from a client for an amount of time left on the timer, e) determine, by the processor, the amount of time left on the timer, f) return, by the processor, to the client, the amount of time left on the timer, and g) repeat steps (d)-(f) until the timer expires.

The computing apparatus may also include instructions that further configure the apparatus to f.1) adjust, by the processor, the duration. The computing apparatus may also include instructions that further configure the apparatus to at least one of: f.2) pause, by the processor, the timer, and f.3) unpause, by the processor, the timer. Other technical features may be readily apparent to one skilled in the art from the following figures, descriptions, and claims.

In one aspect, a non-transitory computer-readable storage medium is provided. The computer-readable storage medium includes instructions that when executed by a computer, cause the computer to a) initializing, by a processor, a timer for an operation, b) set, by the processor, a duration of the timer, c) start, by the processor, the timer, d) receive, by the processor, a request from a client for an amount of time left on the timer, e) determine, by the processor, the amount of time left on the timer, f) return, by the processor, to the client, the amount of time left on the timer, and g) repeat steps (d)-(f) until the timer expires.

The computer-readable storage medium may also include instructions that further configure the computer to f.1) adjust, by the processor, the duration. The computer-readable storage medium may also include instructions that further configure the computer to at least one of f.2) pause, by the processor, the timer, and f.3) unpause, by the processor, the timer. Other technical features may be readily apparent to one skilled in the art from the following figures, descriptions, and claims.

In one aspect, a computer-implemented method is provided, that includes a) initializing, by a processor, a timer for an operation, b) setting, by the processor, a duration of the timer, c) starting, by the processor, the timer, d) receiving, by the processor, a request from a client for an amount of time left on the timer, e) determining, by the processor, the amount of time left on the timer, f) returning, by the processor, to the client, the amount of time left on the timer, and g) repeating steps (d)-(f) until the timer expires.

The computer-implemented method may further comprise: f.1) adjusting, by the processor, the duration. The computer-implemented method may further comprise at least one of f.2) pausing, by the processor, the timer, and f.3) unpausing, by the processor, the timer. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for lockless timer synchronization in accordance with one embodiment.

FIG. 2 illustrates a block diagram in accordance with one embodiment.

FIG. 3 illustrates a block diagram for initializing a timer in accordance with one embodiment.

FIG. 4 illustrates a block diagram for increasing/decreasing duration on the timer, in accordance with one embodiment.

FIG. 5 illustrates a block diagram for requesting remaining time in accordance with one embodiment.

FIG. 6 illustrates a block diagram for pausing a timer in accordance with one embodiment.

FIG. 7 illustrates a block diagram for unpausing a timer in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other data processing apparatus to produce a machine, such that the process creates a means for implementing the functions/acts specified in the schematic flowchart diagrams and/or schematic block diagrams block or blocks.

These instructions may also be stored in a computer readable storage medium that can direct a computer, other data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more devices executing one or more functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

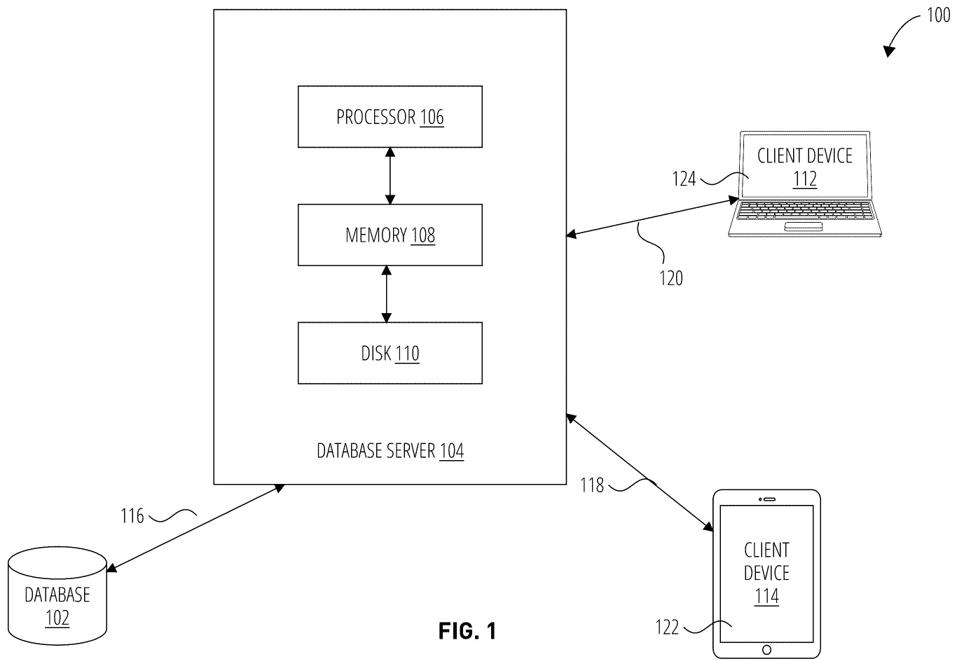

FIG. 1 illustrates an example of a system 100 for lockless timer synchronization.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116.

Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), real-time transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

Systems and methods for lockless timer synchronization can comprise a server, a client and an administrator client device 112.

A client can be a web browser or an application, while an administrator client device 112 can be an administrator version of the web browser/application and the server can be a centralized single server that manages the clients. The timer can be implemented with a number of variables on the server side, all basically centralized.

The client can request how much time is left on a specific operation.

The administrator client device 112 can request: the time left on a specific operation; to pause the timer on an operation; to unpause the timer on an operation; and to increase/decrease the time left on an operation.

The server can store various information about each unique operation that a client performs. Each operation may include the following properties:
1) A state of the timer (whether the timer is “paused” or “unpaused”)
2) A last paused time value: that is, the timer value at the time it was paused. For example, if the timer was paused with 5 seconds left, the last paused time value is 5.
3) A time expired timestamp: that is, the timestamp when the timer will expire.
4) Duration: that is, duration of the operation. This can be implemented in many ways. As an example, duration can be specified by a finite time interval (in seconds, minutes, etc). In another example, instead of duration, a start time and an end time can be specified.

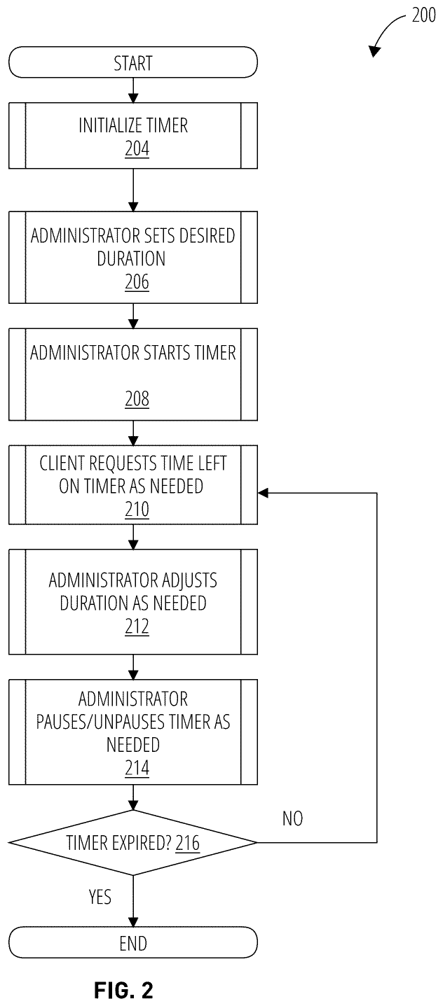

FIG. 2 illustrates a block diagram 200 for Timer Usage Patterns in accordance with one embodiment.

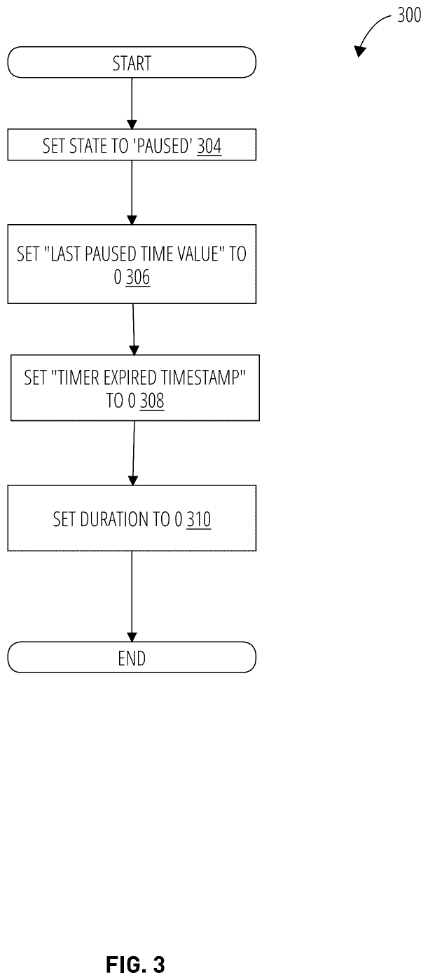

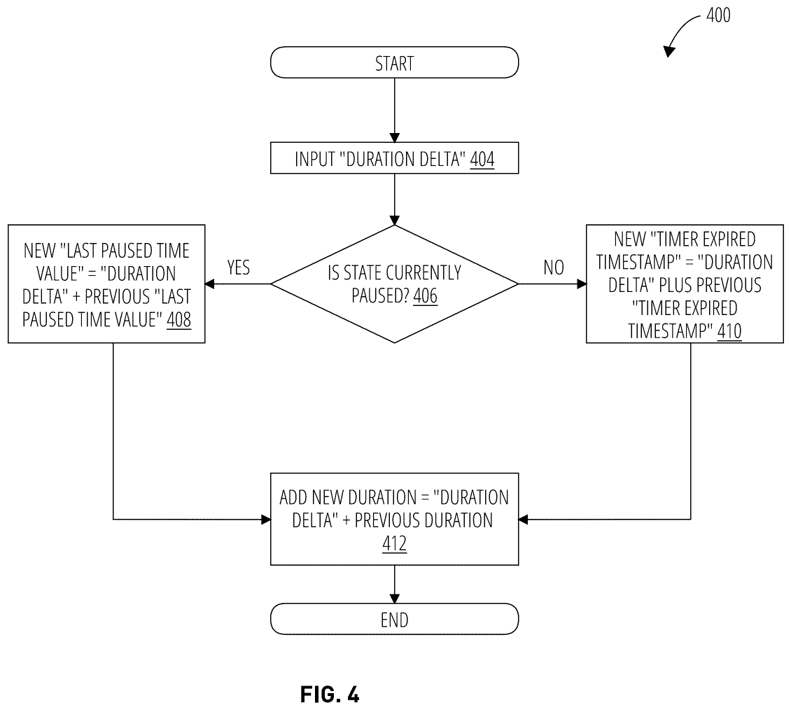

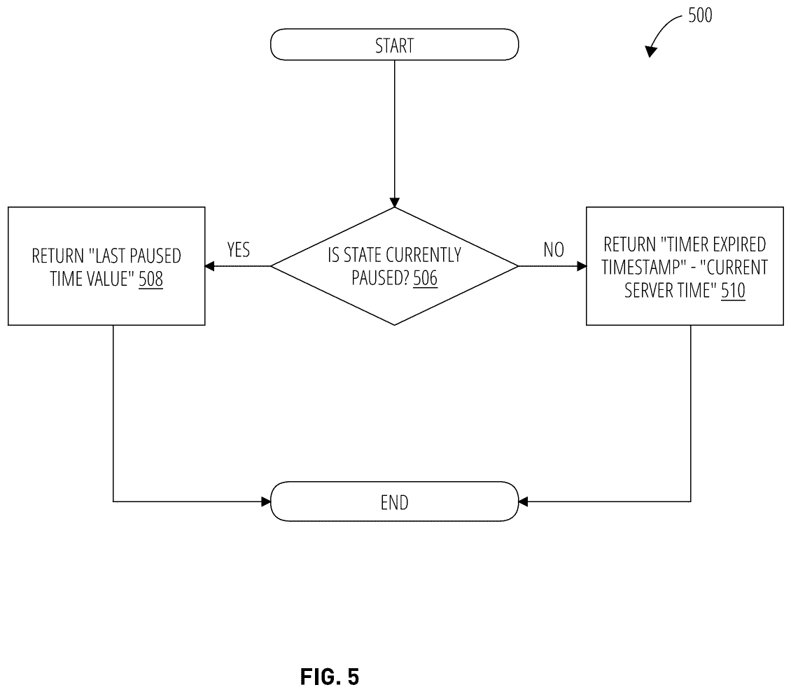

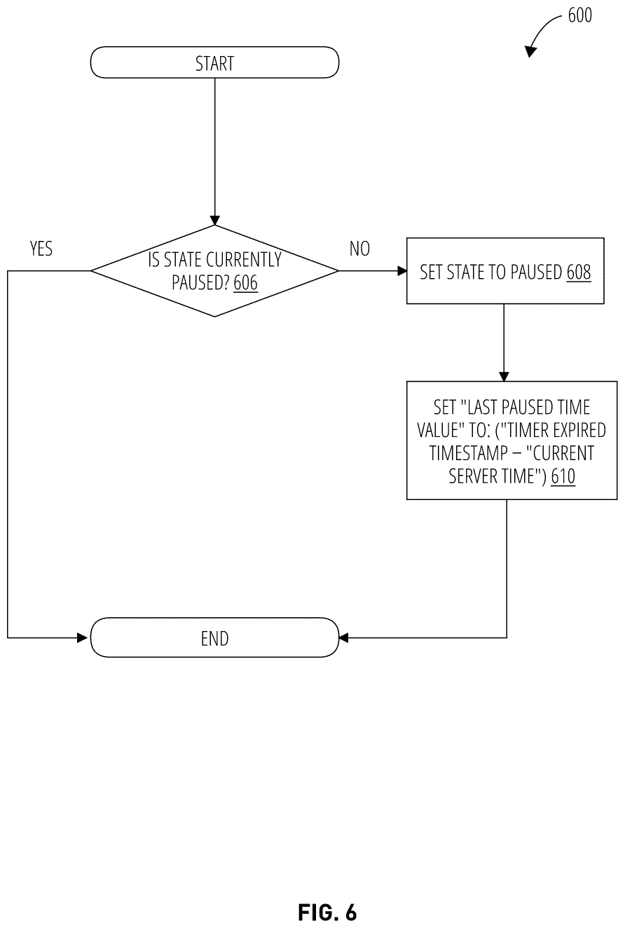

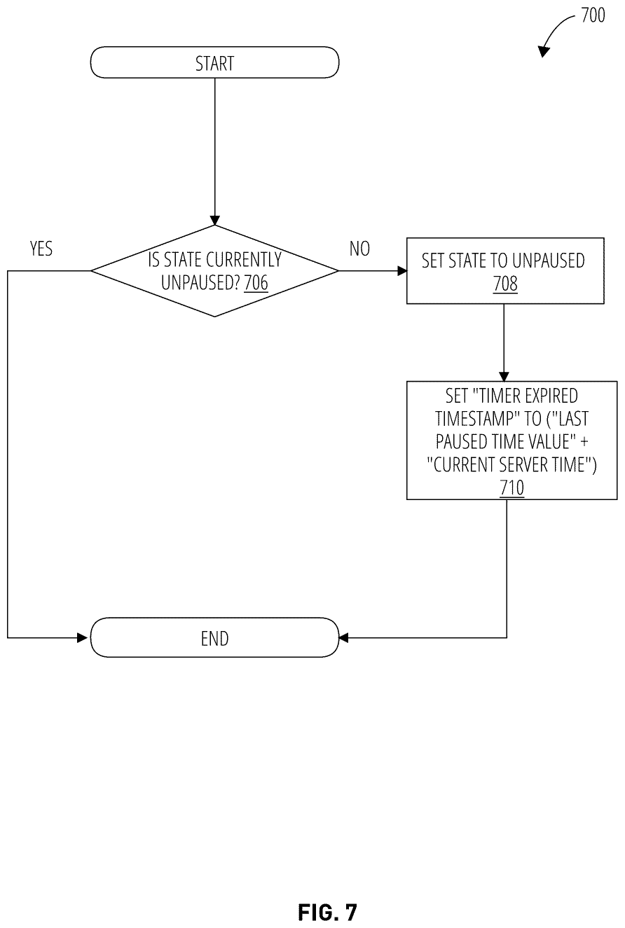

At subroutine block 204, a timer is initialized. This subroutine is described further in FIG. 3. At subroutine block 206, an administrator sets a duration of the timer, which is further described in FIG. 4. The administrator then starts the timer at subroutine block 208 (which is further described in FIG. 7). At this point, a client requests the time left on the timer at subroutine block 210 (which is further described in FIG. 5). At subroutine block 212, the administrator can adjust the duration as needed (described in FIG. 4). At subroutine block 214, the administrator can pause or unpause the timer as needed. A subroutine for pausing the timer is shown in FIG. 6, while a subroutine for unpausing the timer is shown in FIG. 7. If the timer has expired (‘yes’ at decision block 216), then the process ends. Otherwise, it reverts to subroutine block 210, until the timer eventually expires (‘yes’ at decision block 216), and the process ends.

FIG. 3 illustrates a block diagram 300 for initializing a timer in accordance with one embodiment.

An initialization subroutine, where a state of an operation can be initialized, can be summarized as follows:
1. State: paused
2. Last Paused Time Value: 0
3. Timer Expired Timestamp: 0
4. Duration: 0

This is shown in the block diagram 300, where the state is set to ‘paused’ at block 304. At block 306, the last Paused Time Value is set to 0. At block 308, the Timer Expired Timestamp is set to 0. Finally, the Duration can be initially set to 0 at block 310. Where it is initially set to zero, the duration is set, later as outlined in FIG. 4, Note that the duration can be initially set to a non-zero value, and left unchanged at subroutine block 206.

FIG. 4 illustrates a block diagram 400 for increasing/decreasing duration on the timer, by an admin, in accordance with one embodiment. Block diagram 400 can be used to set a duration, as well as change a previously-set duration.

When the administrator client device 112 increases/decreases the duration left on the timer, there are two situations: either the state is paused, or unpaused. If State=‘paused’, then Last Paused Time Value=Last Paused Time Value+New inc/dec duration. If State=‘unpaused’, Time Expired Timestamp=Time Expired Timestamp+New inc/dec duration. Then Set Duration=Duration+New inc/dec duration. This is further elaborated in block diagram 400.

A change in the duration (called “Duration Delta”) is provided at block 404. The change can be positive (that is, an increase in duration) or negative (that is, a decrease in duration). The way the duration delta is added to the duration, depends on whether or not the state is paused.

If the state paused (‘yes’ at decision block 406), then the Duration Delta is added to the Last Paused Time Value. That is, the Last Paused Time Value is updated as follows: New Last Paused Time Value=Duration Delta+Old Last Paused Time Value.

If, on the other hand, the state is unpaused (‘no’ at decision block 406), then the Time Expired Timestamp is updated as follows: New Time Expired Timestamp=Duration Delta plus the Old Timer Expired Timestamp. Finally, the Duration Delta is then added to the current value of the Duration at block 412.

After initializing the timer (subroutine block 204), as described in FIG. 3, the Last Paused Time Value=0, and the State=Paused. Therefore, when setting the duration at this stage, the answer is ‘yes’ at decision block 406. At block 408, the Duration Delta is added to ‘0’ (which is the value of the Last Paused Time Value). Since Duration=0 (from the initialization subroutine block 204), at block 412, the new Duration=Old Duration+Duration Delta, which is equal to the Duration Delta. As an example, if the situation is at the beginning of time, and the timer is paused, and if an extra 10 seconds are added to the timer, then the timer will then indicate 10 seconds.

Subsequent to initialization, the duration can be changed in either an unpaused or paused state. Where the state is unpaused, there is a live change to the duration. In many instances, such a live change is implemented to increase the duration. That is, an administrator client device 112 decides that the duration of the timer is to be extended. Thus, the Timer Expired Timestamp, which is the timestamp that the timer expired, can be extended accordingly. As an example, consider the situation where the timer is counting down and there are 15 seconds left. At this point, the administrator decides to add an extra 10 seconds. The duration is extended by extending the timestamp by 10 seconds.

FIG. 5 illustrates a block diagram 500 for a client requesting remaining time in accordance with one embodiment.

When the client or the administrator client device 112 requests the time remaining on an operation, if the State is already paused, then the Last Paused Time Value is returned to the client or administrator client device 112. If the State is unpaused, then (Time Expired Timestamp−Current Server Time) is returned.

This is elaborated further in block diagram 500, which illustrates that the request is handled differently, depending on whether the state is ‘paused’ or ‘unpaused’. If the state is paused (‘yes’ at decision block 506), then the Last Paused Time Value is returned to the client.

On the other hand, if the state is unpaused (‘no’ at decision block 506), then the client receives the difference between the Timer Expired Time Stamp and the Current Server Time. This is the synchronization step between clients. A client asks the server how much time is left, which is equivalent to asking “when will the timer expire?” The “Timer Expired Timestamp” indicates the timestamp when the timer will expire. The current time is the current server time. It is not the current time at the client. As an example, if the timer is supposed to expire at 10:00 AM (that is, “Timer Expired Timestamp”=Date object representing today's date at 10:00:00:00 AM), and the time currently on the server is 9 AM (that is “Current Time Server”=Date object representing today's date at 9:00:00:00 AM), then the time remaining is “today at 10AM—today at 9 AM”, or one hour. The client receives the answer that 1 hour remains. The synchronization between clients is facilitated by using the Current Server Time, and not a local Client time. For example, clients could be in different time zones. However, the duration would be synchronized across time zones, since a central Current Server Time is being used. In another example: the timer's clock could be desynchronized from the internet. However, this will not affect the synchronization due to the central role of the Current Server Time. A limitation to the synchronization is if two or more clients are across different data centers.

FIG. 6 illustrates a block diagram 600 for pausing a timer by an administrator in accordance with one embodiment.

When an administrator client device 112 pauses, if the State is paused, return. Otherwise, set the State to paused, and set Last Paused Time Value to: Time Expired Timestamp−Current Server Time.

This is elaborated in block diagram 600. If the state is unpaused (‘no’ at decision block 606), then the state is set to paused at block 608. The Last Paused Time Value is set to the Timer Expired Time Stamp minus the Current Server Time, at block 610.

FIG. 7 illustrates a block diagram 700 for unpausing a timer by an administrator in accordance with one embodiment.

When the administrator client device 112 unpauses, if the state is already unpaused, return. Otherwise, set the state to unpaused, and set Timer Expired Timestamp to: Current Server Time+Last Paused Time Value.

This is elaborated in block diagram 700. If the state is paused (‘no’ at decision block 706), then the state is set to unpaused at block 708. The Timer Expired Time Stamp is then set to the sum of the Last Paused Time Value and the Current Server Time, at block 710.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing instructions that, when executed by the processor, configure the apparatus to:
a) initializing, by the processor, a timer for an operation;
b) set, by the processor, a duration of the timer;
c) start, by the processor, the timer;
d) receive, by the processor, a request from a client for an amount of time left on the timer;
e) determine, by the processor, the amount of time left on the timer;
f) return, by the processor, to the client, the amount of time left on the timer; and
g) repeat steps (d)-(f) until the timer expires.

2. The computing apparatus of claim 1, wherein the instructions further configure the apparatus to:
f.1) adjust, by the processor, the duration.

3. The computing apparatus of claim 1, wherein the instructions further configure the apparatus to at least one of:
f.2) pause, by the processor, the timer; and
f.3) unpause, by the processor, the timer.

4. A non-transitory computer-readable storage medium, the computer-readable storage medium including instructions that when executed by a computer, cause the computer to:
a) initializing, by a processor, a timer for an operation;
b) set, by the processor, a duration of the timer;
c) start, by the processor, the timer;
d) receive, by the processor, a request from a client for an amount of time left on the timer;
e) determine, by the processor, the amount of time left on the timer;
f) return, by the processor, to the client, the amount of time left on the timer; and
g) repeat steps (d)-(f) until the timer expires.

5. The computer-readable storage medium of claim 4, wherein the instructions further configure the computer to:
f.1) adjust, by the processor, the duration.

6. The computer-readable storage medium of claim 4, wherein the instructions further configure the computer to at least one of:
f.2) pause, by the processor, the timer; and
f.3) unpause, by the processor, the timer.

7. A method comprising:
a) initializing, by a processor, a timer for an operation;
b) setting, by the processor, a duration of the timer;
c) starting, by the processor, the timer;
d) receiving, by the processor, a request from a client for an amount of time left on the timer;
e) determining, by the processor, the amount of time left on the timer;
f) returning, by the processor, to the client, the amount of time left on the timer; and
g) repeating steps (d)-(f) until the timer expires.

8. The method of claim 7, further comprising:
f.1) adjusting, by the processor, the duration.

9. The method of claim 7, further comprising at least one of:
f.2) pausing, by the processor, the timer; and
f.3) unpausing, by the processor, the timer.
